(19) United States
(12) Patent Application Publication
(10) Pub. No.: US 2014/0231229 A1
(43) Pub. Date: Aug. 21, 2014

(54) CONVEYING DEVICE WITH AN EXTENSIVELY EXTENDED CONVEYING ELEMENT

(71) Applicant: WRH WALTER REIST HOLDING AG, Ermatingen (CH)

(72) Inventor: Robert Aliesch, Gross (CH)

(73) Assignee: WRH WALTER REIST HOLDING AG, Ermatingen (CH)

(21) Appl. No.: 14/179,689

(22) Filed: Feb. 13, 2014

(30) Foreign Application Priority Data
Feb. 18, 2013 (CH) 00474/13

(51) Int. Cl. B65G 41/00

(52) U.S. Cl. CPC B65G 41/00
USPC 198/860.3

(57) ABSTRACT

A conveying device including a revolving, extensively extended conveying element and a frame construction with a plurality of frame profiles for laterally enclosing conveying element. At least two frame profiles of the frame construction are designed as hollow profiles and in their profile longitudinal axis are connected to one another via face-side end sections. The profile walls of the two frame profiles at their face-side end sections are designed such that the two frame profiles form a positive-fit connection, which counteracts forces acting longitudinally, transversely and vertically onto the connection.

### BACKGROUND OF THE INVENTION

1. Field of the Invention

The invention relates to the field of conveying technology and concerns a conveying device. The conveying device comprises at least one revolving, extensively extended conveying element, as well as a frame construction with a plurality of frame profiles for the lateral enclosure of the conveying element. At least two frame profiles of the frame construction are designed as hollow profiles and are connected to one another in their profile longitudinal axis via face-side end sections.

2. Description of Related Art

Conveying devices with a revolving, extensively (two-dimensionally) extended conveying element such as a conveying belt or a mat chain are known in the state of the art. The conveying elements as a rule are driven at one or two deflection locations by way of a deflection shaft. The conveying elements are led in a sliding manner on guide rails between the deflection locations, for supporting these conveying elements in the region of the upper run section, on which the conveyed material lies. Conveying devices are also known, with which the conveying element is supported between the deflection locations on roller bodies and rolls over these.

The conveying device as a rule comprises a frame construction of a plurality of frame profiles. This construction in particular serves as a carrier frame for the components of the conveying device such as the drive, conveying element and support structure for the conveying element. The carrier frame comprises longitudinally running frame profiles that laterally enclose the conveying element, and transverse profiles that connect the longitudinally running frame profiles to one another. These transverse profiles in particular are arranged at the front and rear head-end of the conveying device. Moreover, transverse struts that extend between the lateral frame profiles and are connected to these can be provided between the head-ends.

The mentioned conveying devices are applied for example as worker-rider belts.

DE 10 2006 010 974 A1 and DE 10 2007 017 628 A1 describe a conveying device with a conveying belt as well as an essentially horizontal profile frame with two lateral side-profiles extending in the longitudinal direction of the conveying belt. The conveying device in particular serves a worker-rider belt.

Worker-rider belts are often sunk into the ground, so that the conveying surface that is formed by the conveying element is level with the ground. Steps and shoulders are avoided by way of this, and this considerably simplifies the access and reduces the danger of an accident. Such an arrangement however has the disadvantage that the components of such worker-rider belts are only accessible from above. This renders the assembly and disassembly of the conveying device, as well as the accessibility of the individual components of the conveying devices for maintenance and repair purposes more difficult.

With other applications, for example with storage space management, the components of the conveying device are only accessible from below.

A further demand on the conveying device is the flexible construction length in the conveying direction. Thus, it should be possible to manufacture conveying devices of a different construction length, i.e. with differently long conveying distances, from the same components. An expensive, customised manufacture with different construction lengths is to be avoided in this manner.

### BRIEF SUMMARY OF THE INVENTION

It is therefore the object of the invention, to suggest a conveying device of the initially mentioned type, which on the one hand ensures a good accessibility, even if it is sunk into the ground or floor. Moreover, the conveying device should be able to be designed modularly in different construction lengths whilst using the same components.

This object is achieved by the features of the independent claims 1 and 17. Further preferred embodiments and further developments of the invention are to be deduced from the dependent patent claims, the description as well as from the figures.

The conveying device according to the invention comprises at least one revolving, extensively extended conveying element and a frame construction with a plurality of frame profiles for the lateral enclosure of the conveying element. A frame profile is to be understood as a longitudinally extended component.

At least two frame profiles of the frame construction are designed as hollow profiles and in their profile longitudinal axis are connected to one another via end-face end sections. The at least two frame profiles preferably have the same cross-sectional geometry, wherein deviations due to manufacture, so-called tolerances, are permissible.

The mentioned hollow profiles are longitudinal components, preferably of metal, such as steel or aluminium. The hollow profiles can however be formed of plastic. The hollow profiles can e.g. be extruded profiles.

The invention can now be solved by way of the profile walls of the two frame profiles at their face-side end sections being designed in a manner such that the two frame profiles at their face-side end sections form at least one positive-fit connection. The positive-fit connection counteracts the forces acting on the connection in a longitudinal, transverse and vertical manner.

The frame profiles can form two positive-fit connections at their face-side end sections.

The frame profiles can form three positive-fit connections at their face-side end sections.

The frame profiles can form four positive-fit connections at their face-end end sections.

A positive-fit connection is preferably formed in each case by two side walls of the frame profiles to be connected, said side walls meeting at their face edges.

The two frame profiles are thus lateral longitudinal profiles that run parallel to the conveying direction of the conveying element. The conveying element e.g. comprises an upper run section that forms the conveying surface. Moreover, the conveying element comprises a lower run section that leads back the conveying element. The conveying element in particular is formed in a flexible manner.

The conveying device below the upper run section, in particular between the upper and the lower run section can comprise a support structure for the rolling support of the conveying element or the upper run section, to the bottom. The support structure, which e.g. comprises support rollers, can be supported on the frame construction, in particular on the lateral frame profiles, via transverse struts.

The conveying device moreover can comprise a drive device for driving the conveying element. This drive device can be arranged at a deflection location of the conveying element, e.g. on the front or rear head-end of the conveying device.

The profile walls of the two frame profiles at their face-side end sections are moreover preferably designed in a manner such that one of the two frame profiles is movable vertically upwards or vertically downwards and abuts on the other frame profile in the opposite direction.

The direction descriptions “vertical” or “vertically upwards” and “vertically downwards” relate to the direction of gravity when the conveying surface is aligned horizontally.

The forces that act vertically on the connection are counteracted via a screw connection, so that the two frame profiles are also not vertically movable during the operation of the conveying device. For this, the screw connection comprises a connection screw that is led vertically from the top or vertically from the bottom through the face-side end sections of the frame profiles.

The connection screw is preferably led through the upper profile wall of a first frame profile and through the lower profile wall of the second frame profile that lies opposite the upper profile wall, and fixed.

The connection screw can be led through a support element which is attached in the profile cavity of the first frame profile and supported on this support element, e.g. via the screw head. The support element can be a plate. The support element can extend transversely, e.g. parallel to the upper and lower profile wall, through the profile cavity and be fastened in each case with one end on a lateral profile wall. The support element can be connected to the frame profile via a bond connection, solder connection or weld connection.

The connection screw can be led into a thread element with an inner thread and attached at the outside or inside on the lower or upper profile wall of the second frame profile, depending on whether the screw is inserted from the top or bottom, and screwed to this thread element. The thread element can be a screw nut. The thread element can be connected to the frame profile via a bond connection, a solder connection or a weld connection.

The two lateral profile walls of the two frame profiles in each case in the face-side end section preferably form a first face edge section and a second face edge section that is set back along the profile longitudinal axis with respect to the first face edge section. The mentioned face edge sections preferably run from the upper profile wall in the direction of the lower profile wall or vice versa.

The face edges of the two lateral profile walls, considered transversely to the profile longitudinal axis, form a groove-like recess in the region of the offset between the first and the second face edge section. The groove-like recess in the direction of the profile end preferably merges into a projection directed to the upper or lower profile wall.

The projections are inserted into the groove-like recesses of the counter-profile for creating the profile connection, wherein the projection on a frame profile is directed vertically upwards and the projection on the other frame profile (connection partner) is directed vertically downwards.

The projection in combination with the groove-like recess has the function of a hook. The one frame profile thereby is hung into the recess of the counter-profile via the projection.

Thus, the face edge of the two lateral profile walls considered transversely to the profile longitudinal axis can be designed in a Z-shaped or S-shaped manner in the region of the offset.

The face edges of the two profile walls of the two frame profiles preferably have the same geometry.

The face edges of the lateral profile walls of the frame profiles in the face-side end section are preferably designed equal and opposite to one another, so that the lateral profile walls of the two frame profiles can be joined with a positive fit.

According to a further development of the invention, the upper and/or the lower profile wall of the one frame profile in the face-side end section with its face edge forms a projection aligned along the profile longitudinal axis.

The corresponding upper and/or lower profile wall of the other frame profile in the face-side end section with its face edge forms a recess that is aligned along the profile longitudinal axis and corresponds to the projection. The projection and the recess are preferably designed in an equal and opposite manner, so that the upper and/or lower profile walls of the frame profiles can be joined with a positive fit.

Thus, the first frame profile can have such a projection in the upper as well as in the lower frame profile. Accordingly, the second frame profile has a corresponding recess in the upper as well as in the lower profile wall.

Moreover, the first frame profile in the upper profile wall can have a projection and in the lower profile wall can have recess or vice versa. Accordingly, the second frame profile has a corresponding recess in the upper profile wall, and a corresponding projection in the lower profile wall, or vice versa.

According to an alternative further development of the invention, the one frame profile in the face-side end section comprises a guide element which is arranged on the inner side of the upper and/or lower profile wall and which projects along the profile longitudinal axis of the face edge. The guide element can be a guide plate. The guide element can be connected at the inner side to the upper or lower profile wall via a bond connection, solder connection or weld connection.

Moreover, a side guidance element that projects beyond the face edge can be attached in the face-side end section of the one frame profile on the inner side of the lateral profile walls. The side guidance element in particular can be arranged in the region of the offset between the first and the second face edge section. The side guidance element can be connected at the inner side to the lateral profile wall via a bond connection, solder connection or weld connection.

The guide element that projects from the face edge or the side guidance elements that project from the face edges, with their projecting section engage into the profile cavity in the end section of the counter-profile. The guide element or the side guidance elements hereby preferably slide along the profile walls of the counter-profile at the inner side.

According to a preferred embodiment of the invention, the one frame profile is arranged between two adjacent frame profiles, and at both face-side end sections comprises a downwardly pointing and upwardly pointing projection respectively. The frame profile as a result is designed symmetrically with respect to a vertical axis. The face-side end sections of the frame profiles adjacent to both sides accordingly comprise an upwardly or downwardly pointing projection. As a result, the mentioned frame profile, when the screw connection is released, given downwardly pointing projections can be removed upwards out of the frame and given upwardly pointing projections can be removed downwards out of the frame.

The invention also relates to a kit with at least two frame profiles for creating a frame construction. The frame profiles are designed as hollow profiles and are connectable to one another in their profile longitudinal axis via face-side end sections.

According to the invention, profile walls of the two frame profiles at their face-side end sections are designed in a manner such that the two frame profiles at their face-side end sections can form at least one positive-fit connection, which counteracts the forces acting longitudinally, transversely and vertically onto the connection.

The further developments that are disclosed in the context of the conveying device, and embodiments of frame profiles or their features, also relate to the frame profiles of the kit.

The frame construction can be designed as a frame structure with longitudinally running and transversely running frame profiles that surround the conveying element and thus laterally enclose this. The frame construction in particular can also be designed as a ladder frame with transverse struts.

The conveying device can be applied for conveying bulk goods or piece goods, such as resting goods or even movable goods. Piece goods can be products or living beings, e.g. persons, animals or plants.

The conveying device can e.g. be designed as a moving walkway or flat escalator. Moving walkways or flat escalators are used e.g. at airports, shopping malls or railway stations for conveying persons over a longer distance or through different levels. The moving walkways or flat escalators can have a length of 50 to 150 m.

The conveying device according to the invention is particularly used as a worker-rider belt. Worker-rider belts are applied in industrial manufacture, in which working steps, such as assembly work, has to be carried out on moving-past products of a production line. The worker is co-moved on a worker-rider belt, parallel to the object in the conveying direction, in order to give the worker a sufficient amount of time for him to carry out his working steps on moving-past objects. Such a worker-rider belt can have a length of a few metres e.g. of 6-50 m.

The conveying device according to the invention can also be used as a conveying device for loading and unloading a storage space. The conveying device can e.g. be arranged in a transport means such as road vehicles, lorry, rail vehicle, e.g. freight wagon, ship, e.g. freight ship or air vehicle, e.g. aircraft. Moreover, the conveying device can also be arranged outside the transport means, wherein the freight is transported via the conveying device onto the transport means.

Moreover, the storage space conveying device can also be applied in a freight container or ship container for loading and unloading the container. Such containers serve for the transport of goods by road, by rail, in the air or at sea, and are accordingly transported by road vehicles, rail vehicles, air vehicles or ships.

Moreover, the conveying device according to the invention can also be applied as a storage space conveying device in a storage system, in particular in a high-bay warehouse. The storage system in particular is characterised by a plurality of pallet spaces, wherein transport pallets with goods to be stored are conveyed from or to the storage spaces via the conveying device according to the invention. Here, it may be the case that the conveying device must be accessible from below. I.e. the frame profiles must be able to be released vertically downwards out of the frame construction.

The conveying surface that is formed by the extensively extended conveying element can run in a plane or inclined manner, in the installed condition. The conveying element can be a conveying belt, a conveyor belt or a carrier belt. The conveying element however is preferably a linked conveying chain with a conveying surface, wherein the conveying chain consists in each case of individually chain links that are articulately connected to one another. Such a conveying chain can e.g. be an extensively extended link chain, a modular belt, a plate chain, a modular belt chain or a mat chain. The conveying chain can also be a hinge belt chain or a plate belt chain.

### BRIEF DESCRIPTION OF THE DRAWINGS

The subject-matter of the invention is hereinafter explained in more detail by way of preferred embodiment examples that are represented in the accompanying drawings. In each case are shown schematically in:

FIG. 1 is a perspective view of a section from a conveying device according to the invention;

FIGS. 2a-2b are perspective views of a first embodiment of a profile connection for the frame construction of a conveying device according to FIG. 1;

FIG. 2c is an elevation view of the first embodiment of a profile connection for the frame construction of a conveying device according to FIG. 1; and

FIGS. 3a-3b are perspective views of a second embodiment of a profile connection for the frame construction of a conveying device according to FIG. 1.

### DETAILED DESCRIPTION OF THE INVENTION

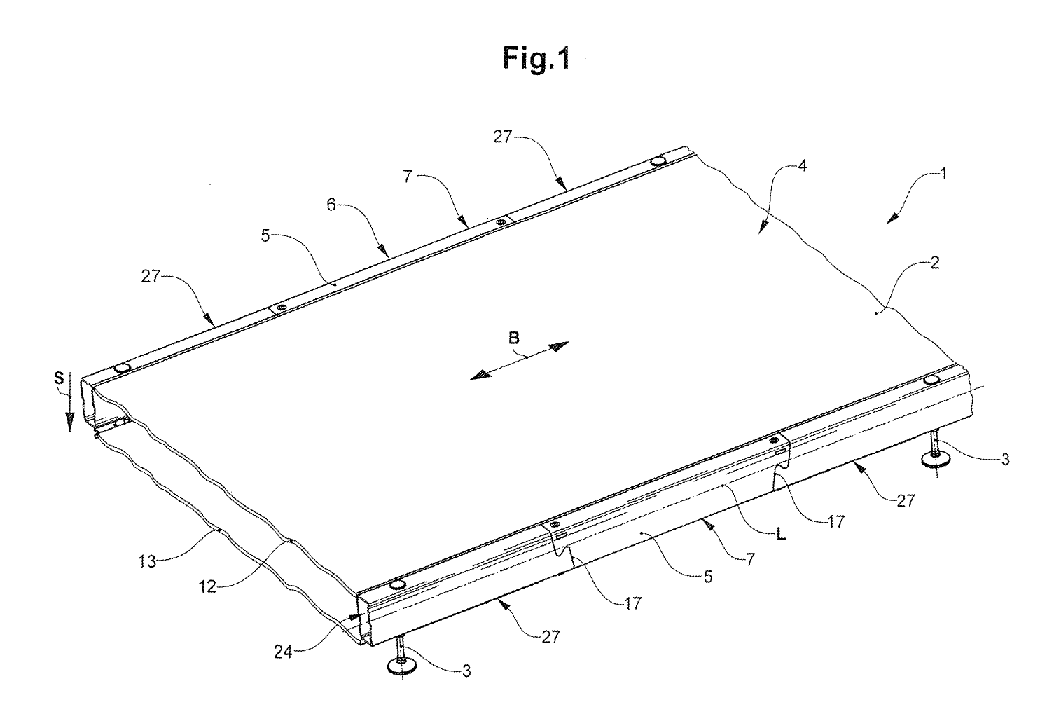

The conveying device 1 according to FIG. 1 comprises a frame construction 6 with longitudinal profiles 5 which are arranged on both sides of an extensively extended, flexible conveying element 2. The frame construction 6 amongst other things serves for the lateral enclosure of the conveying element 2. Moreover, the frame construction 6 forms support frame for individual or all components of the conveying device 1. These can be supported on the frame construction 6 in a direct or indirect manner, or fastened on this. Such components can e.g. be deflection devices for the conveying element 2 at the head-ends of the conveying device 1, a drive device, or a support structure for the conveying element 2.

The conveying element 2 comprises an upper run section 12, which forms the conveying surface 4. Moreover, the conveying element 2 forms a lower run section 13. The lower run section 13 ensures the leading-back of the conveying element 2 opposite to the conveying direction B.

The frame construction 6 and above this moreover the conveying device 1, according to the present embodiment example is supported towards the base floor via support feet 3. The support feet 3 also serve for levelling the conveying device 1.

The longitudinal profiles 5 of the frame construction 6 which extend parallel to the conveying direction B of the conveying element 2 are composed of several frame profiles 7, 27; 57, 77 which are connected to one another in their profile longitudinal axis L via face-end end sections 8, 28; 58, 78. The frame profiles 7, 27; 57, 77 are designed as hollow profiles.

The two lateral profile walls 11 of the two frame profiles 7, 27; 57, 77 in each case in the face-side end section 8, 28; 58, 78 form a first face edge section 17a and a second face edge section 17b which is set back along the profile longitudinal axis L with respect to the first face edge section 17a. The mentioned face edge sections 17a, 17b run from the upper profile wall 9 in the direction of the lower profile wall 10 or vice versa.

The face edges 17 of the lateral profile walls 11, seen transversely to the profile longitudinal axis L form a groove-like recess 18 in the region of the offset between the first and the second face edge section 17a, 17b. The groove-like recess 18 in the direction of the profile ends merges into a projection 22 directed to the upper or lower profile wall 9, 10.

The face edge 17 of the lateral profile walls 11, seen transversely to the profile longitudinal axis L is designed Z-shaped or S-shaped in the region of the offset, depending on the angle of observation.

The face edges 17 of the lateral profile walls 11 of the two frame profiles 7, 27; 57, 77 are designed equal and opposite to one another in the face-side end section 8, 28; 58, 78, so that the lateral profile walls 11 of the frame profiles 7, 27; 57,77 can be joined with a positive fit.

The projections 22 are inserted into the groove-like recesses 18 of the counter-profile for creating the profile connection. For this, that frame profile 7, 57 whose projections 22 point in the direction of the lower profile wall 10, is moved from the top to the bottom in the direction of that frame profile 27, 77 whose projection 22 points in the direction of the upper profile wall 9.

The connection of the frame profiles 7, 27; 57, 77 counteracts forces which act longitudinally, i.e. in the profile longitudinal direction L, on account of the geometry of the face edges 17 of the lateral profile walls 11 which is described above.

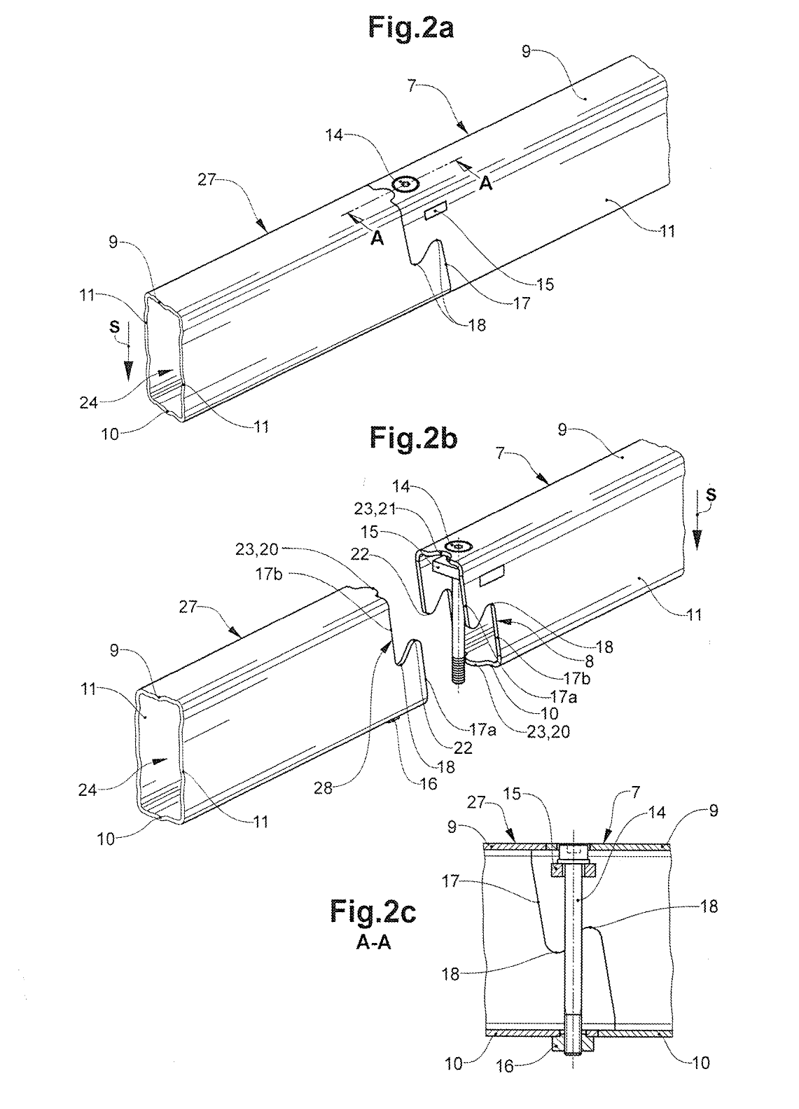

According to first further development of the invention according to FIGS. 2a to 2c, the upper profile wall 9 of the one frame profile 27 in the face-side end section 28 with its face edge 23 forms a projection 20 in the profile longitudinal axis. The upper profile wall 9 of the other frame profile 7 in the face-side end section 8 with its face edge 23 forms a recess 21 corresponding to the projection 20, in the profile longitudinal axis L.

Moreover, the lower profile wall 10 of the one frame profile 27 in the face-side end section 28 and with its face edge 23 forms a recess 20 in the profile longitudinal axis L. The lower profile wall 10 of the other frame profile 7 in the face-side end section 8 with its face edge 23 forms a projection 20 corresponding to the recess 21, in the profile longitudinal axis L.

The projection and the recess are designed in an equal and opposite manner, so that the upper and lower profile walls 9, 10 of the frame profiles 7, 27 can be joined with a positive fit.

The connection of the frame profiles 7, 27 counteracts forces acting transversely (profile transverse direction), i.e. transversely to the profile longitudinal direction L and parallel to the upper and lower profile wall 9, 10, on account of the geometries of the face edges 23 of the upper and lower profile walls 9, 10, said geometry being described above.

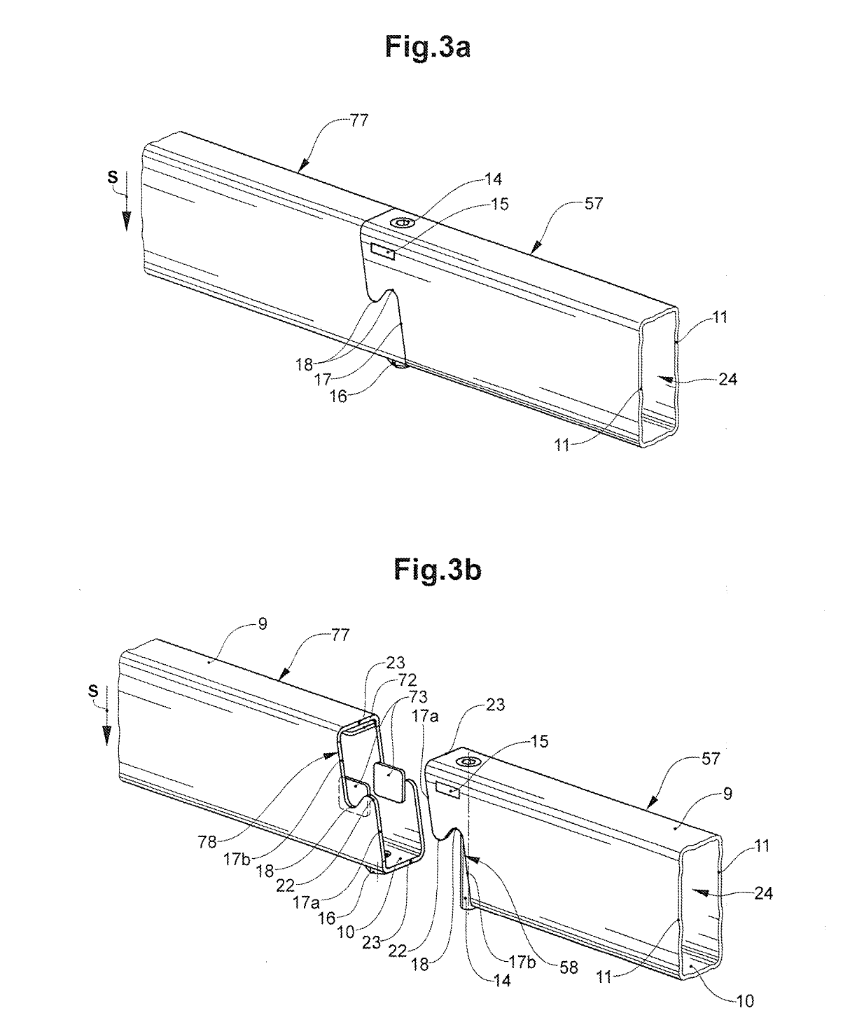

According to a second further development of the invention according to FIGS. 3a and 3b, the one frame profile 77 in the face-side end section 78 comprises a guide plate 72 which is arranged on the inner side of the upper profile wall 9 and which projects along the profile longitudinal axis L of the face edge 23. The guide plate 72 is connected at the inner side to the upper profile wall 9 via a welding connection.

Moreover, in each case a side guidance plate 73 which projects beyond the face edge 17 is attached in the face-side end section 78 of the same frame profile 77 on the inner side of the lateral profile walls 11, in the region of the offset. The respective side guidance plate 73 is connected at the inner side to the lateral profile wall 11 via a welding connection.

The guide plate 72 which projects beyond the face edge 23, and the side guidance plates 73 which project from the face edges 17, with their projecting section in the region of the end section 58 engage into the profile cavity of the counter-profile 57. The guide element 72 or the side guidance elements 73 hereby preferably side on the inner side along the profile walls 9, 11 of the counter-profile 57.

The connection of the frame profiles 77, 57 counteracts forces acting transversely, i.e. transversely to the profile longitudinal direction L and parallel to the upper and lower profile wall 9, 10, on account of the guide plate or side guidance plates 73, which are described above.

The face-side end section 8, 28; 58, 78 of the first frame profile 7, 57, for creating the connection to the second frame profile 27, 77 is now designed identically to the face-side end section 8, 28; 58, 78 of the second frame profile 27, 77 which is not connected to the first frame profile 7, 57.

Accordingly, the face-side end section 8, 28; 58, 78 of the second frame profile 27, 77 for creating the connection to the first frame profile 7, 57 is designed identically to the face-side end section 8, 28; 58, 78 of the first frame profile 7, 57 which is not connected to the second frame profile 27, 77

One can connect infinitely many frame profiles 7, 27; 57, 77 in the profile longitudinal direction L one after the other with a positive fit via their face-side end sections 8, 28; 58, 78 in this manner. Accordingly, conveying devices 1 of a different construction length can be created with the described frame profiles 7, 27; 57, 77.

The two frame profiles 7, 27; 57, 77 are secured to one another via a screw connection, so that they now are also not movable vertically upwards, i.e. perpendicularly to the profile longitudinal axis and perpendicularly to the profile transverse direction, during operation of the conveying device 1. The screw connection for this comprises a connection screw 14 which so led from the top through the face-side end sections 8, 28; 58, 78 of the frame profiles 7, 27; 57, 77.

The connection screw 14 is led through the upper profile wall 9 of the first frame profile 7, 57 and through the lower profile wall 10 of the second frame profile 27, 77.

The connection screw 14 is moreover led through a support plate 15 attached in the profile cavity 24, and is supported on this support plate via the screw head. The support plate 15 extends transversely in the profile cavity 24 and is fastened in each case with one end on a lateral profile wall 11 by way of a welding connection.

The connection screw 14 is moreover led into a screw nut 16 attached at the outside on the lower profile wall 10 by way of a welding connection, and is screwed to this screw nut.

The connection of the frame profiles 7, 27; 57, 77 counteracts the forces acting vertically upwards during operation of the conveying device, by way of the screw connection described above.

If now a connection between two frame profiles 7, 57; 27, 77 is to be created, then that frame profile 7, 57 whose projection 22 is directed to the lower profile wall 10, is lowered in the direction of the other frame profile 27, 77 by way of a downward movement, by which means the frame profiles 7, 57; 27, 77 with their face edges 23, 17 assume a positive-fit connection.

This type of assembly above all is advantageous in those cases, in which the conveying device 1 e.g. is sunk into the ground, and therefore an access is only ensured from above.

If the connection is now to be released and the two frame profiles 7, 57; 27, 77 separated from one another, then the screw connection is released in a first step. That frame profile 7, 57 whose projection 22 is directed to the lower profile wall 10, inasmuch as this is not connected with its other end section to a further frame profile, can now be lifted by way of a movement upwards and released from the frame construction.

1. A conveying device, comprising:
a revolving, extensively extended conveying element;
a frame construction with a plurality of frame profiles for the lateral enclosure of the conveying element,
wherein at least two frame profiles of the frame construction are designed as hollow profiles and in their profile longitudinal axis are connected to one another via face-side end
sections, wherein
profile walls of the two frame profiles at their face-side end sections are designed such that the two frame profiles form at least one positive-fit connection, which counteracts forces acting longitudinally, transversely and vertically onto the connection.

2. The conveying device according to claim 1, wherein the at least one positive-fit connection counteracts a force acting vertically upwards or vertically downwards, onto the connection.

3. The conveying device according to claim 1, wherein the lateral profile walls of the two frame profiles at their face-side end sections are designed such that one of the two frame profiles is movable vertically upwards or vertically downwards and abuts on the other frame profile in the opposite direction.

4. The conveying device according to claim 1, wherein the two frame profiles are connected to one another via a screw connection, and the screw connection counteracts the forces that act vertically upwards and vertically downwards, onto the connection.

5. The conveying device according to claim 4, wherein the screw connection comprises a screw that is led from above or from below through the face-side end sections of the frame profiles, wherein the screw in particular is led through the upper profile wall of the first frame profile and through the lower profile wall of the second frame profile, and fixed.

6. The conveying device according to claim 4, wherein the screw is led through a support element attached in the profile cavity and is supported on the support element.

7. The conveying device according to claim 4, wherein the screw is led into a thread element attached at the outside or inside on the lower or upper profile wall and is screwed to the thread element.

8. The conveying device according to claim 1, wherein the two lateral profile walls of the frame profiles in each case in the face-side end section form a first face edge section and a second face edge section, which is set back with respect to the first face edge section along the profile longitudinal axis.

9. The conveying device according to claim 1, wherein the face edges of the two lateral profile walls of the frame profiles considered transversely to the profile longitudinal axis form a groove-like recess in the region of the offset between the first and the second face edge section.

10. The conveying device according to claim 1, wherein the face edge of the two lateral profile walls of the two frame profiles considered transversely to the profile longitudinal axis is designed in a Z-shaped or S-shaped manner in the region of the offset.

11. The conveying device according to claim 1, wherein the face edges of the lateral profile walls of the two frame profiles in the face-side end section are designed in a manner equal and opposite to one another, so that the lateral profile walls of the frame profiles can be joined with a positive fit.

12. The conveying device according to claim 1, wherein the upper and/or the lower profile wall of the frame profiles in the face-side end section with its face edge forms a projection in the profile longitudinal axis.

13. The conveying device according to claim 1, wherein the upper and/or lower profile wall of the frame profile, in the face-side end section with its face-edge forms a recess in the profile longitudinal axis.

14. The conveying device according to claim 12, wherein the projection and the recess are designed in a manner equal and opposite to one another, so that the upper and/or lower profile walls of the frame profiles can be joined with a positive fit.

15. The conveying device according to claim 1, wherein a guide element that along the profile longitudinal axis projects beyond the face edge is attached in the face-side end section on the inner side of the upper and/or lower profile wall of the one frame profile.

16. The conveying device according to claim 1, wherein a side guidance element that projects beyond the face edge is attached in the face-side end section on the inner side of the lateral profile walls of the one frame profile.

17. A kit with at least two frame profiles for creating a frame construction, wherein the frame profiles are designed as hollow profiles and in their profile longitudinal axis can be connected to one another via face-side end sections,
wherein
profile walls of the two frame profiles at their face-side end sections are designed such that the two frame profiles at their face-side end sections can form at least one positive-fit connection which counteracts forces acting longitudinally, transversely and vertically onto the connection.

18. (canceled)
